(19) United States
(12) Patent Application Publication
(10) Pub. No.: US 2024/0331257 A1
(43) Pub. Date: Oct. 3, 2024

(54) ANIMATION DATA GENERATION

(71) Applicant: Tencent Technology (Shenzhen) Company Limited, Shenzhen (CN)

(72) Inventors: Shun CAO, Shenzhen (CN); Hua KOU, Shenzhen (CN); Yifan CAO, Shenzhen (CN); Nan WEI, Shenzhen (CN); Yu WU, Shenzhen (CN); Congbing LI, Shenzhen (CN); Xiaochun CUI, Shenzhen (CN)

(21) Appl. No.: 18/739,539

(22) Filed: Jun. 11, 2024

Related U.S. Application Data
(63) Continuation of application No. PCT/CN2023/091117, filed on Apr. 27, 2023.

(30) Foreign Application Priority Data
Jul. 15, 2022 (CN) 202210832558.0

(51) Int. Cl. G06T 13/40; G06T 7/246

(52) U.S. Cl. CPC G06T 13/40; G06T 7/246; G06T 2207/20084; G06T 2207/30196; G06T 2207/30241

(57) ABSTRACT

This application describes an animation data generation method and apparatus, and a related product, which may be applied to scenarios such as a cloud technology, artificial intelligence (AI), intelligent transportation, assisted driving, digital human, virtual human, gaming, virtual reality, and extended reality (XR). Features of a virtual object in a virtual scene are obtained, and animation data of the virtual object is generated through a trained neural network based on the features. The use of the neural network omits storage of massive data into an internal memory and query of the massive data for a matched animation during generation of the animation data, and only requires storage of weight data related to the neural network in advance. Therefore, only a small internal memory is occupied, thereby avoiding problems such as large internal memory occupation and poor query performance during generation of the animation data.

### RELATED APPLICATION

This application is a continuation of PCT Application No. PCT/CN2023/091117, filed on Apr. 27, 2023, which claims priority to Chinese Patent Application No. 202210832558.0, filed with the China National Intellectual Property Administration on Jul. 15, 2022 and entitled “ANIMATION DATA GENERATION METHOD AND APPARATUS BASED ON NEURAL NETWORK, AND RELATED PRODUCT”, both of which are incorporated herein by reference in its entirety.

### FIELD OF THE TECHNOLOGY

This application relates to the technical field of architecture intelligence (AI), and in particular, to an animation data generation technology.

### BACKGROUND

For video games, realistic animation effects are required to make the user experience enjoyable. I For example, rendering motions such as running, jumping, squatting, slight breathing or swaying in an idle state, and arm lifting in a panic state improves the user experience.

### SUMMARY

This application describes ways how to generate animation data that requires reduced use of internal memory.

In order to create an animation of a virtual object with different motions, a motion matching technology is provided in the related art. Through the motion matching technology, an animation frame with a largest degree of matching can be selected from massive animations for playback, thereby obtaining the animation of the virtual object with different motions.

However, to drive animation data, during running of the motion matching technology, massive data needs to be stored in an internal memory, and motion matching needs to be performed in the massive data. A large internal memory is occupied, and query performance is poor. The problem limits the development of the motion matching technology in an animation engine. Improvements, however, are required to help improve the user experience.

A first aspect of this application provides an animation data generation method. The animation data generation method is performed by an animation data generation device, and includes: generating a query feature of a virtual object in a virtual scene based on running data of the virtual scene, the query feature including a trajectory feature and a bone feature of the virtual object; increasing a feature dimension of the virtual object through a feature generation network in a neural network based on the trajectory feature and the bone feature of the virtual object, to obtain a combined feature of the virtual object, the neural network being obtained through pre-training; and generating animation data of the virtual object through an animation generation network in the neural network based on the combined feature of the virtual object.

A second aspect of this application provides an animation data generation apparatus. The animation data generation apparatus is deployed on an animation data generation device, and includes: a query feature generation unit, configured to generate a query feature of a virtual object in a virtual scene based on running data of the virtual scene, the query feature including a trajectory feature and a bone feature of the virtual object; a combined feature generation unit, configured to increase a feature dimension of the virtual object through a feature generation network in a neural network based on the trajectory feature and the bone feature of the virtual object, to obtain a combined feature of the virtual object, the neural network being obtained through pre-training; and an animation data generation unit, configured to generate animation data of the virtual object through an animation generation network in the neural network based on the combined feature of the virtual object.

A third aspect of this application provides an animation data generation device, including a processor and a memory, the memory being configured to store a computer program, and transmit the computer program to the processor; and the processor being configured to perform the operations of the animation data generation method described in the first aspect based on instructions in the computer program.

A fourth aspect of this application provides a computer-readable storage medium, configured to store a computer program, the computer program, when executed by an animation data generation device, implementing the operations of the animation data generation method described in the first aspect.

A fifth aspect of this application provides a computer program product, including a computer program, the computer program, when executed by an animation data generation device, implementing the operations of the animation data generation method described in the first aspect.

In aspects of this disclosure, the trajectory feature and the bone feature of the virtual object in the virtual scene are obtained as the query feature, and the animation data of the virtual object is generated through the pre-trained neural network based on the trajectory feature and the bone feature. Since the pre-trained neural network has functions of increasing the feature dimension of the virtual object based on the query feature and generating the animation data of the virtual object based on a high-dimensional feature, an animation data generation requirement can be satisfied. In addition, the use of the neural network omits storage of massive data into an internal memory and query of the massive data for a matched animation during generation of the animation data existing in a conventional motion matching technology. The use of the neural network only requires pre-storage of weight data related to the neural network. Therefore, implementation of the entire solution occupies only a small internal memory, and omits real-time query of massive data, thereby avoiding problems such as large internal memory occupation and poor query performance during generation of the animation data. In addition, since the internal memory occupation is reduced and required queries are reduced, for example, in a game scene, a game runs more smoothly, and more storage space can be used for other purposes, thereby improving performance of the game in other aspects, for example, improving game picture quality. In this way, gaming experience of a player is improved.

### BRIEF DESCRIPTION OF THE DRAWINGS

FIG. 1 is a schematic diagram showing an example animation state machine.

FIG. 2 is an architecture diagram depicting an example scenario for implementing an animation data generation method according to various examples of this disclosure.

FIG. 3 is a flowchart depicting an example animation data generation method according to various examples of this disclosure.

FIG. 4 is a schematic structural diagram depicting an example neural network according to various examples of this disclosure.

FIG. 5A is a schematic structural diagram of a neural network depicting an example various examples of this disclosure

FIG. 5B is a flowchart depicting an animation data generation method according to various examples of this disclosure.

FIG. 6 is a schematic structural diagram depicting an example of a feature generation network according to various examples of this disclosure.

FIG. 7 is a schematic structural diagram depicting an example of a feature updating network according to various examples of this disclosure.

FIG. 8 is a schematic structural diagram depicting an example of an animation generation network according to various examples of this disclosure.

FIG. 9A is a flowchart depicting a method of training a neural network according to various examples of this disclosure.

FIG. 9B is a schematic diagram depicting an example of a root bone trajectory before noise reduction according to various examples of this disclosure.

FIG. 9C is a schematic diagram depicting an example of a root bone trajectory after noise reduction according to various examples of this disclosure.

FIG. 10A is a schematic structural diagram depicting an example of a deep learning network according to various examples of this disclosure.

FIG. 10B is a schematic diagram depicting an example animation of effects according to various examples of this disclosure.

FIG. 11 is a schematic structural diagram of an animation data generation apparatus according to various examples of this disclosure.

FIG. 12 is a schematic structural diagram depicting an example of an animation data generation apparatus according to various examples of this disclosure.

FIG. 13 is a schematic structural diagram depicting a server according to various examples of this disclosure.

FIG. 14 is a schematic structural diagram depicting a terminal device according to various examples of this disclosure.

### DETAILED DESCRIPTION ASPECT

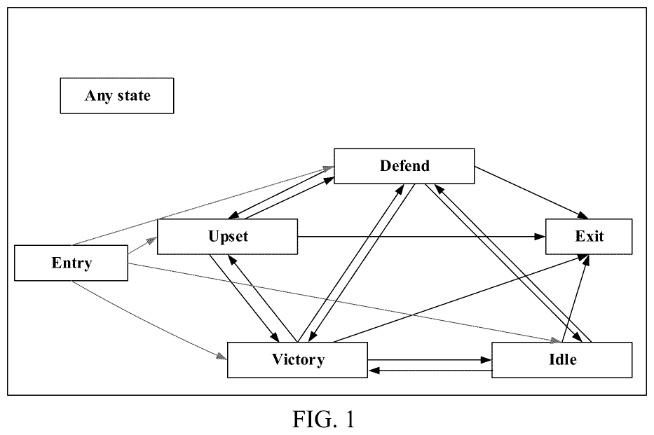

During animation production or game development, animations are often controlled through design of a state machine. FIG. 1 is a schematic diagram showing such a state machine. In the state machine shown in FIG. 1, defend, upset, victory, and idle represent four different animations, and bidirectional arrows among the four animations represent switching between the animations. During game development or animation production, if an animation is generated in a conventional manner of using the state machine, when a motion of a virtual object is relatively complex, a design amount of the state machine is very large, and subsequent updating and maintenance are very difficult, which requires a large amount of time and easily causes a fault.

In view of the above, a motion matching technology is generated. The motion matching technology resolves problems of a large design amount of the animation state machine, a complex logic, and inconvenient maintenance. However, the motion matching technology requires pre-storage of massive animation data for querying and matching. Therefore, a large internal memory is occupied, which causes poor storage and query performance.

In view of the above problems, an animation data generation method and apparatus, and a relevant product are provided in this application. When an animation of a virtual object needs to be generated, animation data of the virtual object may be generated by using a pre-trained neural network based on an obtained query feature (a trajectory feature and a bone feature) of the virtual object. Compared to an implementation of pre-storing massive animation data for querying and matching to obtain an animation effect of the virtual object, the neural network can improve storage and query performance because weight data of the neural network occupies only a small internal memory. The advantage enables the solutions described in this disclosure to achieve more desirable application and development in an animation engine.

The animation data generation method provided in application mainly involves an artificial intelligence (AI) technology, and in particular, involves machine learning in the AI technology. The problems of the motion matching technology regarding storage and query performance in animation production and movie production are resolved by using a neural network trained through machine learning.

For purposes of clarity, the following terms are described in non-limiting ways. But these example definitions and explanations of the terms should not be construed to limit the scope of this disclosure.

### 1) Machine Learning

It is an interdisciplinary field, involving a plurality of disciplines such as the theory of probability, statistics, the approximation theory, convex analysis, and the theory of algorithm complexity. The machine learning specializes in how a computer simulates or realizes learning behaviors of humans to obtain new knowledge or skills, and reorganizes existing knowledge structures to keep improving performance thereof. The machine learning is the core of AI, and is a branch of the AI. The machine learning is a fundamental way to make computers intelligent, which is applied to all fields of the AI. The machine learning and deep learning generally include technologies such as an artificial neural network, a confidence network, reinforcement learning, transfer learning, inductive learning, and learning from demonstration. A research history of the AI has a coherent and clear line focusing on “reasoning” and then on “knowledge” and then on “learning”. Apparently, the machine learning is a way for implementing the AI. To be specific, a problem in the AI is resolved through the machine learning.

### 2) Neural Network

A neural network is a mathematical model or a computing model that imitates a structure and a function of a biological neural network in the fields of machine learning and cognitive science, which is configured to perform function estimation or approximation. The neural network is composed of a large quantity of artificial neurons connected for computation. In most cases, an internal structure of the artificial neural network may be changed based on external information. The artificial neural network is an adaptive system. Popularly speaking, the artificial neural network has a learning function.

### 3) Motion Capturing

Motion capturing is also referred to as dynamic capturing, which is used to capture the motion of a human or another object.

### 4) Virtual Scene

A virtual scene is a simulated scene of the world of the game that is being played, or may be a semi-simulated and semi-fabricated scene, or may be a completely fabricated three-dimensional scene. The virtual scene may be any one of a two-dimensional virtual scene, a 2.5-dimensional virtual scene, or a three-dimensional virtual scene. In the following examples, a description is provided by using an example in which the virtual scene is the three-dimensional virtual scene, but this application is not limited thereto. In a possible implementation, the virtual scene is further used for a virtual scene battle between at least two virtual objects. The virtual scene may be, for example, a game scene, a virtual reality scene, or an extended reality (XR) scene, which is not limited in the examples of this application.

### 5) Virtual Object

It is a movable object in a virtual scene. The movable object may be at least one of a virtual character, a virtual animal, or a cartoon character. In a possible implementation, when the virtual scene is a three-dimensional virtual scene, the virtual object may be a three-dimensional model created based on an animation bone technology. Each virtual object has a shape and a volume of the virtual object in the three-dimensional virtual scene, and occupies a partial space in the three-dimensional virtual scene.

The animation data generation method described herein may be performed by an animation data generation device. The animation data generation device may be, for example, a terminal device. To be specific, in the terminal device, a query feature is generated and animation data is generated based on a neural network, which is in some instances pre-trained. In an example, the terminal device may specifically include but is not limited to a mobile phone, a computer, an intelligent voice interaction device, a smart home appliance, an on-board terminal, and an aircraft. The examples of the present disclosure are applicable to various scenarios, including but not limited to a cloud technology, AI, digital human, virtual human, gaming, virtual reality, and XR. In addition, the above animation data generation device may alternatively be a server. To be specific, in the server, a query feature may be created and animation data may be generated based on a pre-trained neural network.

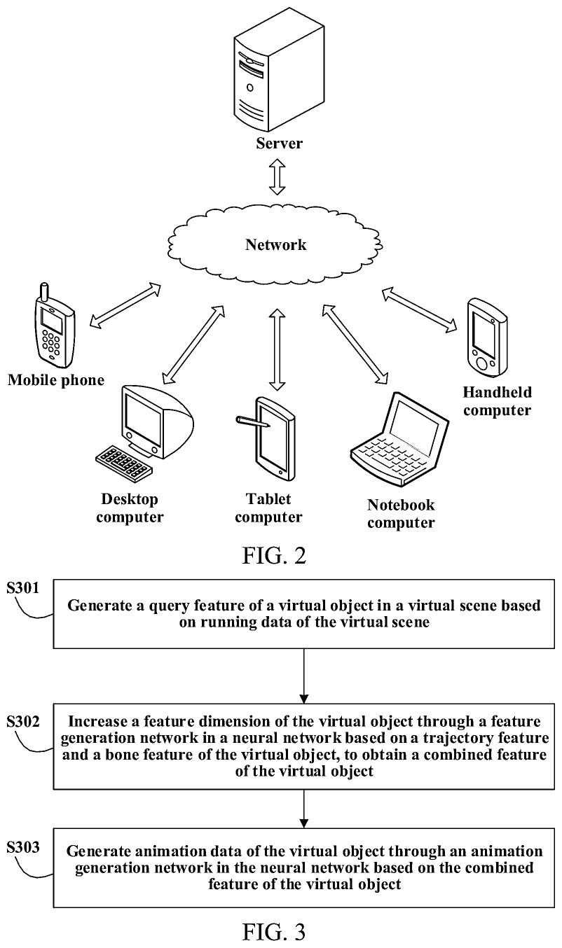

In some other implementations, the animation data generation method provided in the examples of this application may alternatively be jointly implemented through the terminal device and the server. FIG. 2 is an architecture diagram of a scenario for implementing an animation data generation method according to an example of this application. For ease of understanding of the technical solution provided in this example of this application, an implementation scenario of the solution is described below with reference to FIG. 2. In the implementation scenario, a terminal device and a server are involved. For example, running data of a virtual scene may be extracted in the terminal device to generate a query feature of a virtual object in the virtual scene, weight data of a neural network may be retrieved from the server, and animation data of the virtual object may be generated in the terminal device based on the neural network. In addition, the query feature of the virtual object in the virtual scene may be generated in the server based on the running data of the virtual scene, the query feature may be transmitted to the terminal device, and then the animation data is generated in the terminal device by using the neural network. An implementation body for performing the technical solutions of this application is not limited in this example of this application.

The server shown in FIG. 2 may be an independent physical server, or may be a server cluster composed of a plurality of physical servers or a distributed system. In addition, the server may alternatively be a cloud server that provides basic cloud computing services such as a cloud service, a cloud database, cloud computing, a cloud function, cloud storage, a network service, cloud communication, a middleware service, a domain name service, a security service, a CDN, a big data platform, and an AI platform.

FIG. 3 is a flowchart of an example animation data generation method according to an example of this application. A specific implementation of the method is described below by using a terminal device as an execution body. The animation data generation method shown in FIG. 3 includes the following steps:
S301: Generate a query feature of a virtual object in a virtual scene based on running data of the virtual scene.

A game scene is used as an example. When a player controls a virtual object, the virtual object needs to display a corresponding animation effect based on the control of the player. For example, the virtual object performs a walking motion. When the player controls the virtual object to perform a squatting motion, an animation in which the virtual object performs the squatting motion needs to be displayed in the virtual scene (that is, the game scene). Animation data of the squatting motion needs to be generated through the technical solutions provided in this application. In order to generate animation data of the virtual object matching an operation objective of the player, in the technical solutions provided in this application, the query feature of the virtual object first needs to be generated, which is used as an input of a neural network in subsequent steps, and finally the animation data is generated.

The query feature may include a trajectory feature and a bone feature of the virtual object. The so-called trajectory feature may be a feature in the virtual scene related to a trajectory of the virtual object. The trajectory feature is a feature of the overall virtual object. Correspondingly, the bone feature is a feature of an individual bone of the virtual object. For example, the trajectory feature in the query feature may include a trajectory velocity and a trajectory direction. In addition, the trajectory feature may further include a trajectory point position. The bone feature in the query feature may include left-foot bone position information, left-foot bone rotation information, right-foot bone position information, and right-foot bone rotation information. In addition, the bone feature may further include a left-foot bone velocity and a right-foot bone velocity.

A trajectory in the trajectory feature may be a trajectory of a root joint of the virtual object. The trajectory may be a path formed by a projection of a hip bone of the virtual object on a ground. If the virtual object is a human-shaped character, the generation method includes projecting hip bone information of a human-shaped bone onto the ground. In this case, a plurality of animation frames may be connected to form the trajectory point information of the virtual object. The ground herein may be specifically a ground in a coordinate system of the virtual scene. Bone features of both feet are incorporated in the query feature. Since feet are an important part of a human body for representing a posture, bone information of the feet in terms of position, rotation, and the like facilitates generation of a matched animation through the neural network. In this application, the trajectory feature and the bone feature are used as the query feature, and the features of the virtual object are represented as the overall bone feature and the individual bone of the virtual object. The combination of the two types of features facilitates accurate generation of the animation data, and ensures that a motion display effect of the virtual object is vividly depicted in the generated animation data.

In an optional implementation of the step, the generating a query feature of a virtual object in a virtual scene based on running data of the virtual scene may specifically include the following steps:
extracting a motion control signal for the virtual object from the running data of the virtual scene; and generating the trajectory feature and the bone feature of the virtual object based on a control parameter in the motion control signal and a historical control parameter in a historical motion control signal for the virtual object.

During game running, whether a character walks or runs mainly depends on an input of the player. If the player expects the character to run, the player inputs a corresponding motion control signal through a keyboard and a joystick. In this case, an animation engine calculates a proper running velocity as the trajectory feature based on the motion control signal. The historical control parameter in the past historical motion control signal may be used during the operation. For example, the control parameter may include a motion type (such as running, jump, and walking). In addition, the trajectory feature and the bone feature of the virtual object may be generated in combination with a role attribute of the virtual object. For example, different role attributes have different maximum velocity values and minimum velocity values. Herein, the historical motion control signal may be a motion control signal received before a latest received motion control signal is received. For example, the historical motion control signal may be a last motion control signal received before the latest received motion control signal is received, or may be a motion control signal previously received within a preset time. Through the historical control parameter in the historical motion control signal, more precise and more real-time trajectory feature and bone feature can be generated.
S302: Increase a feature dimension of the virtual object through a feature generation network in the neural network based on the trajectory feature and the bone feature of the virtual object, to obtain a combined feature of the virtual object.

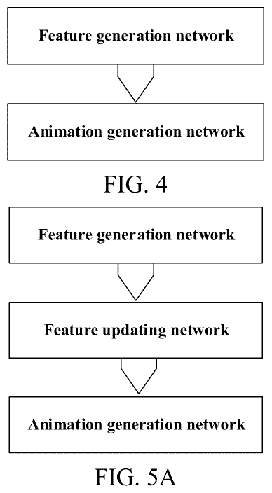

FIG. 4 is a schematic structural diagram of an example neural network according to one or more aspects of this application. A network structure exemplified in the figure includes the feature generation network and an animation generation network. The feature generation network may be configured to increase the feature dimension of the virtual object, that is, enriches a query feature dimension of the virtual object through the feature generation network. For example, the query feature inputted to the feature generation network includes the trajectory velocity, the trajectory direction, the left-foot bone position information, the left-foot bone rotation information, the right-foot bone position information, and the right-foot bone rotation information. Through processing of the feature generation network, an outputted feature not only includes the feature information in the inputted query feature, but also includes another auxiliary feature that facilitates accurate generation of the animation data. A manner of obtaining the auxiliary feature is described below in more details. For distinguishing between the inputted feature and the outputted feature in the text, in this aspect of this application, a feature with increased dimensions processed by the feature generation network is referred to as a combined feature. Since the combined feature is obtained based on the inputted trajectory feature and bone feature, it may be understood that the combined feature outputted by the feature generation network match the query feature inputted to the feature generation network, and may be used as the combined feature of the virtual object for generating the animation data.
S303: Generate animation data of the virtual object through an animation generation network in the neural network based on the combined feature of the virtual object.

The network structure shown in FIG. 4 further includes an example animation generation network. A function of the network is to generate the animation data of the virtual object based on the combined feature of the virtual object inputted to the network. In a practical application, a combined feature of the virtual object in each frame of the animation engine may be used as an input of the animation generation network, to generate animation data of the frame. Then a coherent animation is formed in chronological order based on the animation data of the animation engine in each frame. Therefore, based on a function requirement on the neural network, the output of the feature generation network may be directly used as the input of the animation generation network for training and use when the neural network needs to satisfy the functional requirement.

In the animation data generation method described in this aspect of this application, since the pre-trained neural network has functions of increasing the feature dimension of the virtual object based on the query feature and generating the animation data of the virtual object based on a high-dimensional feature, an animation data generation requirement can be satisfied. In addition, the use of the neural network omits storage of massive data into an internal memory and query of the massive data for a matched animation during generation of the animation data existing in a conventional motion matching technology. The use of the neural network only requires storage of weight data related to the neural network in advance. Therefore, during the implementation of the entire solution, only a small internal memory is occupied, thereby avoiding problems such as large internal memory occupation and poor query performance during generation of the animation data. Therefore, the solution in this aspect of this application can achieve more desirable application and development in an animation engine.

In some possible implementations, the feature generation network may not run every frame, so as to improve performance and reduce animation jitters during running of the solution. In other words, S302 needs to be performed under a specific condition. For example, in a case that changes of the trajectory feature and the bone feature of the virtual object satisfy a first preset condition, and/or a time interval from previous combined feature outputting of the feature generation network satisfies a second preset condition, the combined feature of the virtual object is outputted through the feature generation network based on a latest outputted trajectory feature and bone feature of the virtual object. That is to say, in the possible implementation, running of the feature generation network needs to satisfy a precondition. The precondition may be a condition related to feature changes (for example, the first preset condition), or may be a condition related to a running time interval (for example, the second preset condition), or may be a combination thereof.

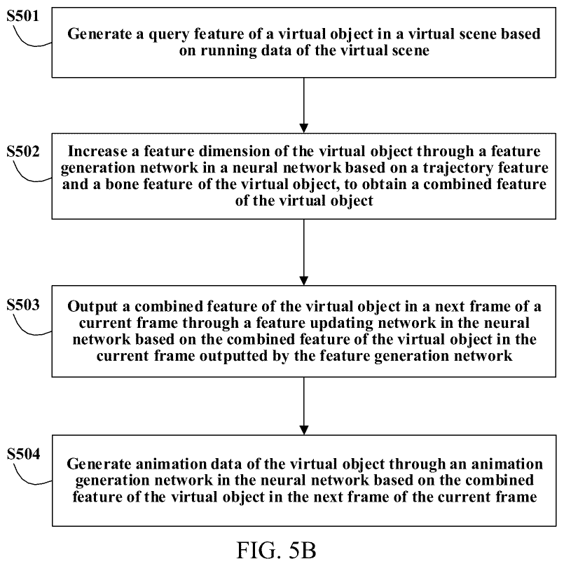

Since the feature generation network may not run every frame in some possible implementations, to ensure an animation effect and ensure generation of a smooth animation, another neural network structure may be used to generate the animation data in this application. FIG. 5A is a schematic structural diagram of another neural network according to an aspect of this application. Compared to the network structure shown in FIG. 4, the neural network shown in FIG. 5A further includes a feature updating network. In the structure shown in FIG. 5A, the output of the feature generation network is used as an input of the feature updating network. An output of the feature updating network is used as the input of the animation generation network. When the feature generation network does not run, generation of a next animation frame is driven through the feature updating network, to ensure smoothness and continuity of the animation. FIG. 5B is a flowchart of another animation data generation method according to an aspect of this application. A neural network structure used in the method shown in the figure is consistent with the neural network structure shown in FIG. 5A. To be specific, the neural network includes a feature generation network, a feature updating network, and an animation generation network.

The example animation data generation method shown in FIG. 5B includes the following steps:
S501: Generate a query feature of a virtual object in a virtual scene based on running data of the virtual scene.
S502: Increase a feature dimension of the virtual object through the feature generation network in the neural network based on the trajectory feature and the bone feature of the virtual object, to obtain a combined feature of the virtual object.

Implementations of S501 to S502 in this aspect of this application are substantially the same as the implementations of S301 to S302 in the above aspect. Therefore, for the relevant description, reference may be made to the aspect provided above, which is not described herein.

When the example feature generation network does not run every frame, the combined feature of the virtual object generated by the feature generation network during running may be a combined feature of the virtual object in a current frame.
S503: Output a combined feature of the virtual object in a next frame of the current frame through the feature updating network in the neural network based on the combined feature of the virtual object in the current frame outputted by the feature generation network.
S503 shows the function of the feature updating network in the neural network shown in FIG. 5A. In an optional implementation, S503 may be implemented through outputting of the combined feature of the virtual object in the next frame of the current frame by the feature updating network based on the combined feature of the virtual object in the current frame outputted by the feature generation network and a delta time of an animation engine of the virtual scene. The delta time may a time difference between two updating of an animation logic thread of the animation engine. Generally, the delta time is close to a game update rate. For example, if the game update rate is 60 frames per second, the delta time is 1/60 seconds. In other words, in this aspect of this application, the feature updating network can obtain the combined feature of the same dimension of the virtual object in the next frame based on the combined feature of the current frame. In other words, the feature updating network implements updating of the combined features of the virtual object between a preceding frame and a succeeding frame that are adjacent. The feature updating network updates the combined feature in the succeeding frame based on the combined feature in the preceding frame. In this way, coherence and smoothness of subsequent animation data outputted by the animation generation network can be implemented through the function of the feature updating network when the feature generation network does not work in real time.

S504: Generate the animation data of the virtual object through the animation generation network in the neural network based on the combined feature of the virtual object in the next frame of the current frame.

In S504 in this aspect of this application, since the output of the feature updating network is used as an input of the animation generation network, the animation generation network directly generates the animation data based on the combined feature in the next frame inputted therein and outputs the animation data.

In this aspect of this application, the feature generation network does not run every frame, so as to improve performance and reduce animation jitters during running of the solution. In addition, through the feature updating network, coherence and smoothness of the animation can be ensured even if the feature generation network does not run every frame.

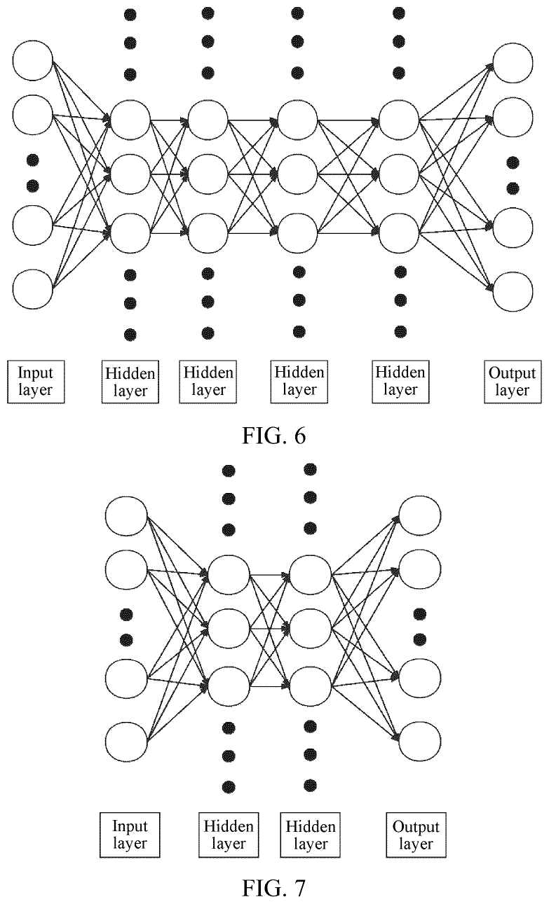

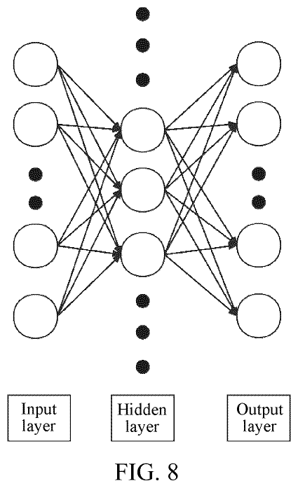

FIG. 6 is an example schematic structural diagram of a feature generation network according to an aspect of this application. FIG. 7 is a schematic structural diagram of a feature updating network according to an aspect of this application. FIG. 8 is a schematic structural diagram of an animation generation network according to an aspect of this application. In the examples shown in FIG. 6 to FIG. 8, a structure of the feature generation network is a fully connected network with six layers that include four hidden layers, and a quantity of units in each hidden layer is 512. A structure of the feature updating network is a fully connected network with four layers that include two hidden layers, and a quantity of units in each hidden layer is 512. A structure of the animation generation network is a fully connected network with three layers that include one hidden layer. A quantity of units in each hidden layer is 512. In other implementations, the above three networks each may include another quantity of hidden layers or include a hidden layer including another quantity of units. Therefore, the network structure with the 6+4+2 layers and the 512 units in the neural network are merely used as an implementation, but this application is not limited thereto.

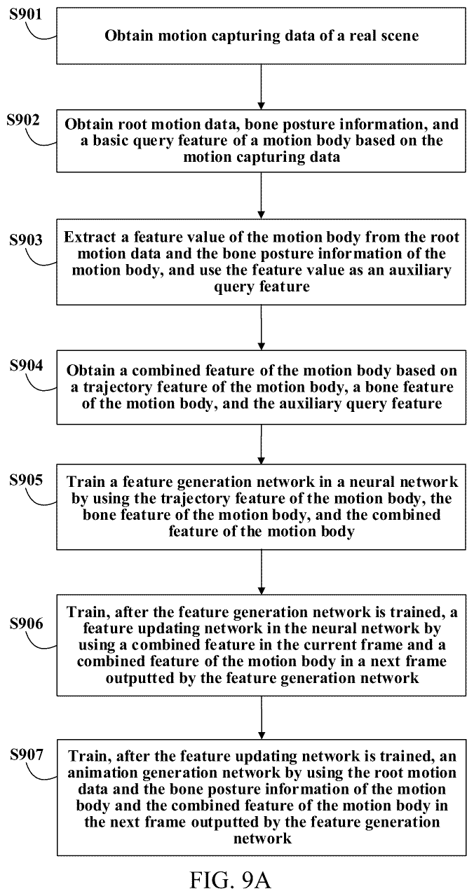

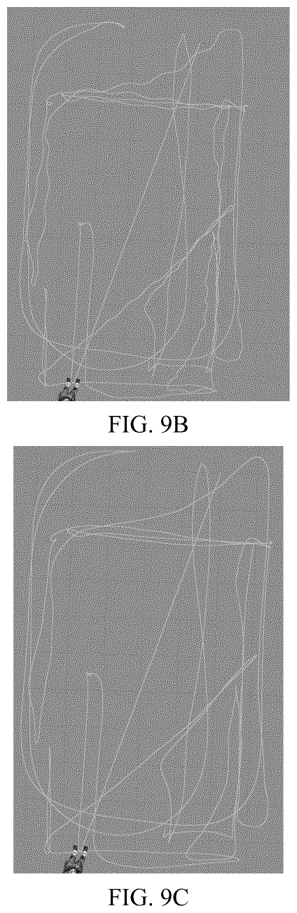

In the above example method, the neural network configured to generate the animation data of the virtual object based on the query feature is described, and the structure thereof is exemplarily described. A neural network training method for the network structure shown in FIG. 5A is described below with reference to FIG. 9A. FIG. 9A is a flowchart of training a neural network according to an aspect of this application. As shown in the example of FIG. 9A, the training of the neural network may include the following steps:
S901: Obtain motion capturing data of a real scene.

An objective of obtaining the motion capturing data of the real scene is to train the neural network. A motion capturing technology has been described above, which is a relatively mature technology currently applied to fields such as film production, animation production, and game development. In this aspect of this application, motion capturing data of a human body in the real scene is obtained through the technology. In an example, to improve accuracy of training, the step may be implemented in the following manner:

A motion capturing route and a plurality of preset motions that need to be captured are designed. When a motion body (which is usually a human, for example, a cast, or may be an animal) moves based on a preset motion capturing route and performs a preset motion in the real scene, motion capturing is performed on the motion body, to obtain initial motion capturing data. The initial motion capturing data is processed in at least one of the following preprocessing manners, to obtain processed motion capturing data: noise reduction, data extension, or generation of data in a coordinate system of an animation engine adapting to the virtual scene. The processed motion capturing data usually may be directly applied to subsequent S902.

The initial motion capturing data is preprocessed through at least one of noise reduction or data extension. Since quality of the motion capturing data can be improved through noise reduction, and an amount of motion capturing data can be increased through data extension, massive data is provided for training the neural network. Therefore, a training effect can be improved in the above preprocessing manners.

In some scenarios, a collection device configured to collect the motion capturing data may has signal noise. In order to avoid noise in the captured data that affects the training effect of the neural network, noise reduction may be performed on the initial motion capturing data. For example, the initial motion capturing data may be processed through filtering by using a Savitzky-Golay (SG) filter. For a position of a bone root node of motion capturing data of each frame, least squares fitting is performed on data of preceding N frames and succeeding N frames, that is, data of a total of 2N+1 frames. The least squares method requires that a squared difference of the data be as small as possible. Then, a value for a current frame is selected from the fitted curve as a fitting result. Selection of a value of N is related to a quantity of frames of an animation and a data change between the frames of the animation. If the animation has a relatively large quantity of frames and the few changes exist between the frames, N needs to be larger to successfully and smoothly achieve noise reduction. Generally, a larger N indicates a stronger noise reduction effect. In an example, N=50. In a practical application, filtering may be performed in another manner, and the SG filter is merely used as an implementation example. Through filtering, a trajectory curve in the motion capturing data is smoother, and disturbances are reduced. FIG. 9B and FIG. 9C are schematic diagrams of a root bone trajectory before and after noise reduction according to an aspect of this application. It can be easily found with reference to FIG. 9B and FIG. 9C that after the noise reduction, the motion capturing data obtained by using the root bone trajectory as an example has reduced noise and a smoother trajectory.

In some scenarios, an amount of the initial motion capturing data is relatively small. In order to improve performance of the neural network trained subsequently, the initial motion capturing data may be extended. An extension manner may include performing the data extension on the initial motion capturing data through a mirroring method, and/or performing the data extension on the initial motion capturing data in a timeline zooming manner. In an example, through the mirroring method, left walking can be mirrored to right walking and right walking can be mirrored to left walking during motion capturing, thereby increasing a data amount in each mode. In the animation data, data of only one walk of the motion body may be captured. For example, current data indicates that a left foot moves forward first and then a right foot moves forward. In order to extend a dataset, for example, the data indicates that the right foot moves forward first and then the left foot follows forward, the mirroring method needs to be used for extension. The data extension in the timeline zooming manner means extending the data by increasing or reducing a trajectory velocity. In this method, a rate in the animation data is mainly adjusted, to simulate generation of motion capturing data at different motion velocities. For example, the initial motion capturing data indicates a walking motion along a path up to 100 meters completed in 30 seconds. A timeline is zoomed in, for example, the timeline is zoomed in to a timeline having a double length, so that the initial motion capturing data indicates a walking motion along a path up to 100 meters completed in 60 seconds. It may be learned from the above that, zooming in on the timeline means reducing a motion velocity of an execution body corresponding to the data. Similarly, zooming out on the timeline means increasing the motion velocity of the execution body corresponding to the data. The timeline is zoomed out, for example, the timeline is zoomed out to a timeline having a half length, so that the initial motion capturing data indicates a walking motion along a path up to 100 meters completed in 15 seconds. In the implementation of zooming in on the timeline, linear interpolation is performed on an extra time. In the implementation of zooming out the timeline, the data may be filtered regularly based on a time sequence. The extension of the motion capturing data in the above manners provides massive data for training the neural network, which improves the performance of the neural network.

In addition to the noise reduction and the data extension, since a difference exists between coordinate systems of the real scene and the virtual scene, and final obtained animation data needs to be mapped to the coordinate system of the virtual scene, data in a coordinate system adapting to the animation engine in the virtual scene may be generated based on the initial motion capturing data in this step. In this way, a basic database for training the neural network can be constructed. For example, the initial motion capturing data is data in a right-hand coordinate system, and the coordinate system of the animation engine is a left-hand coordinate system with a Z axis facing upward. Conversion may be performed based on a coordinate system relationship, to generate the motion capturing data in the coordinate system of the animation engine.

In other words, in a practical application, to improve the training effect, the initial motion capturing data may be processed in at least one of the following preprocessing manners, to obtain the processed motion capturing data: noise reduction, data extension, or generation of data in a coordinate system of an animation engine adapting to the virtual scene.
S902: Obtain root motion data, bone posture information, and a basic query feature of a motion body based on the motion capturing data,

The basic query feature may include a trajectory feature and a bone feature of the motion body. The basic query feature herein has the same type as that of a query feature that needs to be inputted to the feature generation network after the training of the neural network is completed. The trajectory feature in the basic query feature may be generated based on a movement direction and a position of the motion body. The bone feature in the basic query feature may be obtained based on motion information of both feet of the current motion body.

The root motion data and the bone posture information of the motion body obtained based on the motion capturing data are information, other than the basic query feature, that facilitates the training of the feature generation network and increase of a query feature dimension obtained from the motion capturing data in this step.
S903: Extract a feature value of the motion body from the root motion data and the bone posture information of the motion body, and use the feature value as an auxiliary query feature.

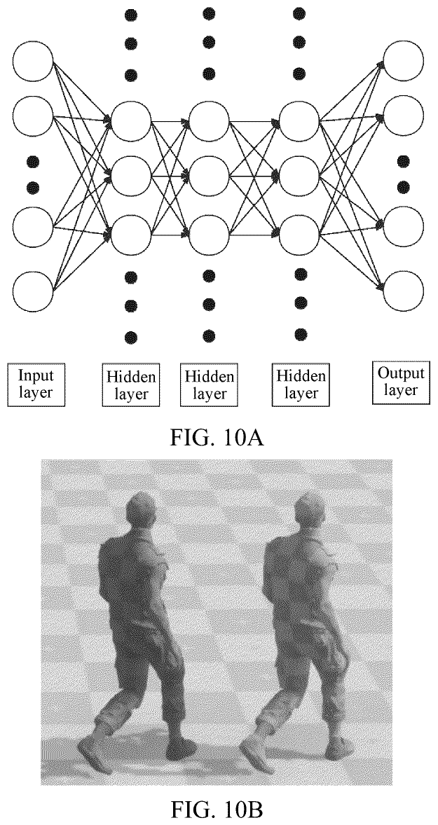

In this aspect of this application, S903 may be completed by another trained deep learning network. A function of the neural network is to extract the feature value as the auxiliary query feature. The features in this aspect of this application, such as the query feature, the basic query feature, the auxiliary query feature, and the combined feature, may be represented by feature vectors. Vector representation of the auxiliary query feature may also be referred to as an auxiliary vector. The auxiliary vector is a digit generated by the deep learning network that performs S903. A vector dimension is consistent with the feature dimension. FIG. 10A is a schematic structural diagram of a deep learning network that can extract an auxiliary query feature according to an aspect of this application. The deep learning network shown in FIG. 10A may be a fully connected network with five layers that include 3 hidden layers. A low dimension feature vector that represents input data is gradually obtained after passing through each hidden layer. A final output is the auxiliary vector that needs to be used together with the vector representation of the basic query feature for training the feature generation network.
S904: Obtain a combined feature of the motion body based on the trajectory feature of the motion body, the bone feature of the motion body, and the auxiliary query feature.

The combined feature of the motion body may be obtained based on the basic query feature (that is, the trajectory feature of the motion body and the bone feature of the motion body) and the auxiliary query feature. Through the auxiliary query feature, dimension increase of the query feature can be implemented based on the basic query feature. As described above, the function of the feature generation network is to increase the feature dimension to the query feature. Therefore, in this aspect of this application, the feature generation network in the neural network may be trained by using the basic query feature and the combined feature as a set of training data. The basic query feature is used as an input of the feature generation network in the training phase, and the combined feature of the motion body is used as an output result of the above input. Reference is made to the following S905.
S905: Train the feature generation network in the neural network by using the trajectory feature of the motion body, the bone feature of the motion body, and the combined feature of the motion body.

In an example application, a training ending condition may be set for the feature generation network. For example, it is determined whether to end the training based on a training iteration frequency and/or a loss function. Similarly, training ending conditions may be set for the feature updating network and the animation generation network. In this aspect of this application, the training of the neural network is performed in sequence. The feature generation network is trained first, then the feature updating network is trained, and finally the animation generation network is trained. Training the above networks in such a way can ensure performance of each network after training. For the processes of training the feature generation network and the animation generation network in such a way, reference is made to the following S906 and S907.
S906: Train, after the feature generation network is trained, the feature updating network in the neural network by using a combined feature in the current frame and a combined feature of the motion body in the next frame outputted by the feature generation network, the combined feature of the motion body in the next frame being obtained based on the motion capturing data of the motion body.

The combined feature of the motion body in the next frame is obtained based on the motion capturing data of the motion body. The combined feature of the motion body in the next frame is used as an output result of the trained feature updating network. The combined feature in the current frame outputted by the feature generation network is used as an actual input of the trained feature updating network.
S907: Train, after the feature updating network is trained, the animation generation network by using the root motion data and the bone posture information of the motion body and the combined feature of the motion body in the next frame outputted by the feature generation network.

The root motion data and the bone posture information of the motion body are used as an output result of the trained animation generation network. The combined feature of the motion body in the next frame outputted by the feature generation network is used as an actual input of the trained animation generation network.

The entire neural network is trained through the above steps. The neural network can be used in the animation data generation method provided in the aspects of this application. In Table 1, a storage occupation required by the conventional motion matching method for each content is compared with a storage occupation required by the animation data generation method provided in the aspects of this application for each content.

TABLE 1

| | Motion matching | Technical solutions of |
|---|---|---|
| | technology | this application |
| Animation database | 43M | 0M |
| Feature database | 10M | 0M |
| Network weight data | 0M | 5M |
| Total memory | 53M | 5M |

It may be learned from Table 1 that, compared to the solution of the motion matching technology, this application can greatly reduce occupation of the storage space during generation of the animation data, which improves storage performance. FIG. 10B is a schematic diagram of animation effects respectively obtained by using a conventional motion matching method and an animation data generation method according to an aspect of this application. A human-shaped animation on a left side is obtained through the conventional motion matching method, and a human-shaped animation on a right side is obtained through the technical solutions of this application. It is easily found from the animation effect figures on the left and right sides in FIG. 10B that the final animation effect obtained through the technical solutions of this application is very close to the animation effect obtained through the motion matching method. In other words, a relatively desirable effect is achieved, and an animation data generation requirement is satisfied. The improvement in the storage performance achieves smoother game operation and smoother animation viewing while ensuring the animation effect, and the improvement in the storage performance allows more storage space for an improvement in other aspects, for example, a further improvement in game picture quality, storage of more user game data, and enrichment data related to a virtual character or scene data. Therefore, gaming experience of a player is further improved.

A practical application of the animation data generation method provided in the aspects of this application is described below in combination with a game scene. A game runs in a terminal device. A player operates the game in real time, and controls a virtual object to perform motions such as running, jump, and dodge in the game scene through a mouse and a keyboard. When the player presses an F key on the keyboard, based on settings of the game, the virtual object controlled by the player needs to perform the jump motion in the virtual scene. When the player presses a T key on the keyboard, based on the settings of the game, the virtual object controlled by the player needs to run in the virtual scene. Through the method provided in the aspects of this application, the terminal device can determine a motion control intention of the player through a control parameter and a historical control parameter in a motion control signal inputted by the player through the mouse and/or the keyboard, and calculate a query feature of the virtual object. After calculating the query feature of the virtual object, the terminal device communicates with a remote server to call the neural network. After the weight data of the neural network is called, the weight data is stored locally in the terminal device. The terminal device uses the query feature as an input of the neural network. The neural network is pre-trained in the server based on motion capturing data of some real scenes. Therefore, the terminal device can actually locally store the weight data of the neural network or retrieve the weight data of the neural network from the server and locally store the weight data of the neural network, to perform an operation based on the input content, and finally output the animation data of the virtual object. The terminal device renders, by using some rendering methods through the animation engine, the animation data of the virtual object into an animation effect that can be seen by the player from the game scene displayed on the terminal device. Based on the method described above, when the player presses the F key on the keyboard, the virtual object controlled by the player jumps to the air in the virtual scene displayed on a screen of the terminal device, and the animation shows that the virtual jumping object takes a changing posture, with both feet separated by a larger distance than other postures. Based on the method described above, when the player presses the key T on the keyboard, the virtual object controlled by the player makes a running posture in the virtual scene displayed on the screen of the terminal device, regularly swinging both arms and alternately moving legs with an amplitude exceeding that in a walking posture. The entire process from the control performed by the player on the terminal device to the displaying of the corresponding animation effect in the virtual scene picture spends little time, so that displaying of another picture in the game producing is prevented from freezing or an area mosaic effect as a result a control instruction.

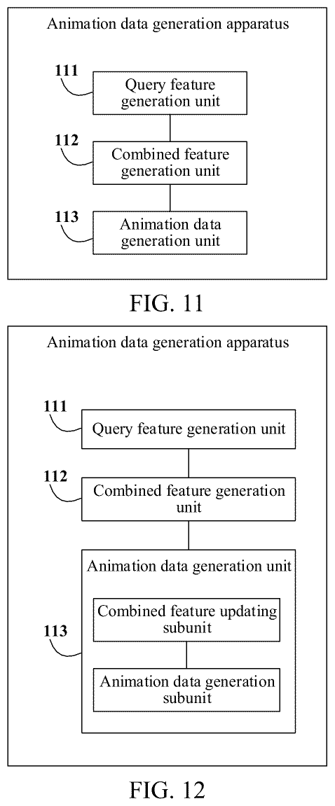

FIG. 11 is a schematic structural diagram of an animation data generation apparatus according to an aspect of this application. As shown in FIG. 11, the animation data generation apparatus includes:
a query feature generation unit 111, configured to generate a query feature of a virtual object in a virtual scene based on running data of the virtual scene, the query feature including a trajectory feature and a bone feature of the virtual object;
a combined feature generation unit 112, configured to increase a feature dimension of the virtual object through a feature generation network in a neural network based on the trajectory feature and the bone feature of the virtual object, to obtain a combined feature of the virtual object, the neural network being obtained through pre-training; and
an animation data generation unit 113, configured to generate animation data of the virtual object through an animation generation network in the neural network based on the combined feature of the virtual object.

Since the pre-trained neural network has functions of increasing the feature dimension of the virtual object based on the query feature and generating the animation data of the virtual object based on a high-dimensional feature, an animation data generation requirement can be satisfied. In addition, the use of the neural network omits storage of massive data into an internal memory and query of the massive data for a matched animation during generation of the animation data existing in a conventional motion matching technology. The use of the neural network only requires storage of weight data related to the neural network in advance. Therefore, during the implementation of the entire solution, only a small internal memory is occupied, thereby avoiding problems such as large internal memory occupation and poor query performance during generation of the animation data.

FIG. 12 is a schematic structural diagram of another animation data generation apparatus according to an aspect of this application. In the apparatus structure exemplified in FIG. 12, the combined feature of the virtual object is a combined feature of the virtual object in a current frame, and the animation data generation unit 113 specifically includes: a combined feature updating subunit, configured to output a combined feature of the virtual object in a next frame of the current frame through a feature updating network in the neural network based on the combined feature of the virtual object in the current frame outputted by the feature generation network; and an animation data generation subunit, configured to generate the animation data of the virtual object through an animation generation network in the neural network based on the combined feature of the virtual object in the next frame of the current frame.

In a possible implementation, the combined feature generation unit 112 is specifically configured to: output the combined feature of the virtual object through the feature generation network based on a latest outputted trajectory feature and bone feature of the virtual object in a case that changes of the trajectory feature and the bone feature of the virtual object satisfy a first preset condition and/or a time interval from previous combined feature outputting of the feature generation network satisfies a second preset condition.

In a possible implementation, the combined feature updating subunit is specifically configured to: output the combined feature of the virtual object in the next frame of the current frame through the feature updating network based on the combined feature of the virtual object in the current frame and a delta time of an animation engine adapting to the virtual scene.

In a possible implementation, the animation data generation apparatus may further include a network training unit configured to obtain the neural network through training. The network training unit specifically includes: a motion capturing data obtaining subunit, configured to obtain motion capturing data of a real scene; a data analysis subunit, configured to obtain root motion data, bone posture information, and a basic query feature of a motion body based on the motion capturing data, the basic query feature including a trajectory feature and a bone feature of the motion body; a feature value extraction subunit, configured to extract a feature value of the motion body from the root motion data and the bone posture information of the motion body, and use the feature value as an auxiliary query feature; a feature combination subunit, configured to obtain a combined feature of the motion body based on the trajectory feature of the motion body, the bone feature of the motion body, and the auxiliary query feature; a first training subunit, configured to train the feature generation network in the neural network by using the trajectory feature of the motion body, the bone feature of the motion body, and the combined feature of the motion body; a second training subunit, configured to train, after the feature generation network is trained, the feature updating network in the neural network by using a combined feature in the current frame and a combined feature of the motion body in the next frame outputted by the feature generation network, the combined feature of the motion body in the next frame being obtained based on the motion capturing data of the motion body; and a third training subunit, configured to train, after the feature updating network is trained, the animation generation network by using the root motion data and the bone posture information of the motion body and the combined feature of the motion body in the next frame outputted by the feature generation network.

In a possible implementation, the motion capturing data obtaining subunit is specifically configured to: perform motion capturing on the motion body in a case that the motion body moves based on a preset motion capturing route and performs a preset motion in the real scene, to obtain initial motion capturing data; and process the initial motion capturing data in at least one of the following preprocessing manners to obtain processed motion capturing data: noise reduction, data extension, or generation of data in a coordinate system of an animation engine adapting to the virtual scene.

In a possible implementation, the data extension manner may include but is not limited to: performing the data extension on the initial motion capturing data through a mirroring method; and/or performing the data extension on the initial motion capturing data in a timeline zooming manner.

In a possible implementation, the query feature generation unit 111 includes: a signal extraction subunit, configured to extract a motion control signal for the virtual object from the running data of the virtual scene; and a feature generation subunit, configured to generate the trajectory feature and the bone feature of the virtual object based on a control parameter in the motion control signal and a historical control parameter in a historical motion control signal for the virtual object.

In a possible implementation, the trajectory feature includes a trajectory velocity and a trajectory direction, and the bone feature includes left-foot bone position information, left-foot bone rotation information, right-foot bone position information, and right-foot bone rotation information, a trajectory being formed based on a projection of a hip bone.

A structure of an animation data generation device is described in a form of a server and in a form of a terminal device.

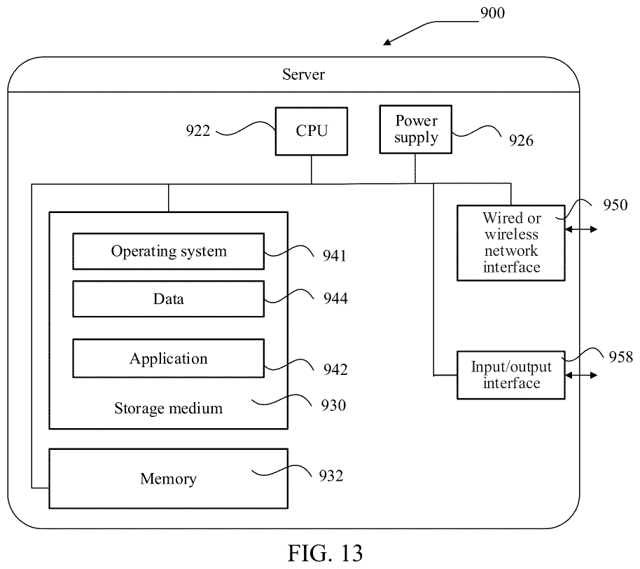

FIG. 13 is a schematic structural diagram of a server according to an aspect of this application. A server 900 may vary greatly due to different configurations or performance, and may include one or more central processing units (CPUs) 922 (for example, one or more processors) and a memory 932, and one or more storage media 930 (for example, one or more mass storage devices) having an application 942 or data 944 stored therein. The memory 932 and the storage medium 930 may be a transitory storage or a persistent storage. A program stored in the storage medium 930 may include one or more modules (not shown in the figure), and each module may include a series of instruction operations in the server. Further, the CPUs 922 may be configured to communicate with the storage medium 930, and perform, on the server 900, the series of instruction operations in the storage medium 930.

The server 900 may further include one or more power supplies 926, one or more wired or wireless network interfaces 950, one or more input/output interfaces 958, and/or one or more operating systems 941 such as Windows Server™, Mac OS X™, Unix™, Linux™, and FreeBSD™.

The CPUs 922 are configured to perform the following steps: generating a query feature of a virtual object in a virtual scene based on running data of the virtual scene, the query feature including a trajectory feature and a bone feature of the virtual object; increasing a feature dimension of the virtual object through a feature generation network in a neural network based on the trajectory feature and the bone feature of the virtual object, to obtain a combined feature of the virtual object, the neural network being obtained through pre-training; and generating animation data of the virtual object through an animation generation network in the neural network based on the combined feature of the virtual object.

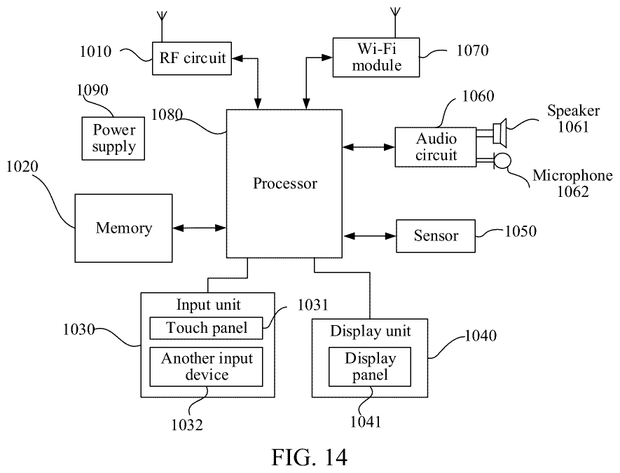

An aspect of this application further provides another animation data generation device. The animation data generation device may be a terminal device. As shown in FIG. 14, for ease of description, only parts related to this aspect of this application are shown. For specific technical details not disclosed, reference is made to the method part of the aspects of this application. The terminal device may be any terminal device such as a mobile phone, a tablet computer, a personal digital assistant (PDA), a point of sales (POS), or an on-board computer. An example in which the terminal device is the mobile phone is used.

FIG. 14 is a block diagram of a partial structure of an example mobile phone related to the terminal device provided in the aspects of this application. Referring to FIG. 14, the mobile phone includes components such as a radio frequency (RF) circuit 1010, a memory 1020, an input unit 1030, a display unit 1040, a sensor 1050, an audio circuit 1060, a wireless fidelity (Wi-Fi) module 1070, a processor 1080, and a power supply 1090. The input unit 1030 may include a touch panel 1031 and another input device 1032. The display unit 1040 may include a display panel 1041. The audio circuit 1060 may include a speaker 1061 and a microphone 1062. It may be understood that the structure of the mobile phone shown in FIG. 14 does not constitute a limitation on the mobile phone, and the mobile phone may include more components or fewer components than those shown in the figure, or some merged components, or different component arrangements.

The memory 1020 may be configured to store a software program and a module, and the processor 1080 executes various function applications of the mobile phone and performs data processing by running the software program and the module stored in the memory 1020. The memory 1020 may mainly include a program storage area and a data storage area. The program storage area can store an operating system, an application required by at least one function (for example, a sound playback function and an image playback function), and the like. The data storage area can store data (for example, audio data and a phone book) created based on use of the mobile phone. In addition, the memory 1020 may include a high-speed random access memory, and may further include a nonvolatile memory, such as at least one magnetic disk storage device, a flash memory device, or another volatile solid-state storage device.

The processor 1080 is a control center of the mobile phone, which is connected to all parts of the entire mobile phone by using various interfaces and lines, and performs various functions and data processing of the mobile phone by running or executing the software program and/or module stored in the memory 1020 and calling the data stored in the memory 1020, so as to perform overall data and information collection on the mobile phone. In some aspects, the processor 1080 may include one or more processing units. Preferably, an application processor and a modem processor may be integrated into the processor 1080. The application processor mainly processes an operating system, a user interface, an application, and the like. The modem processor mainly processes wireless communication. It may be understood that the above modem processor may alternatively not be integrated into the processor 1080.

In this aspect of this application, the processor 1080 included in the terminal further has the following functions: generating a query feature of a virtual object in a virtual scene based on running data of the virtual scene, the query feature including a trajectory feature and a bone feature of the virtual object; increasing a feature dimension of the virtual object through a feature generation network in a neural network based on the trajectory feature and the bone feature of the virtual object, to obtain a combined feature of the virtual object, the neural network being obtained through pre-training; and generating animation data of the virtual object through an animation generation network in the neural network based on the combined feature of the virtual object.

An aspect of this application further provides a computer-readable storage medium, which is configured to store a computer program. The computer program, when executed by an animation data generation device, implements any implementation of the animation data generation method in the above aspects.

An aspect of this application further provides a computer program product, which includes a computer program. The computer program product, when run in a computer, causes the computer to perform any implementation of the animation data generation method in the above aspects.

A person skilled in the art can clearly understand that, for convenient and brief description, for specific working processes of the above system and device, reference may be made to the corresponding processes in the above method aspects. The details are not described herein.

It is to be understood from the aspects provided in this application that the disclosed system and method may be implemented in another manner. For example, the system aspects described above are merely exemplary. For example, division of systems is merely logical function division and may be another division manner during actual implementation. For example, a plurality of systems may be combined or integrated into another system, or some features may be omitted or not performed. In addition, the displayed or discussed mutual couplings or direct couplings or communication connections may be implemented by using some interfaces. The indirect couplings or communication connections between the apparatuses or units may be implemented in an electronic, mechanical, or another form.

The systems described as separate components may or may not be physically separated, and the components displayed as units may or may not be physical units, and may be at one position, or may be distributed on a plurality of network units. Some or all of the units may be selected based on actual requirements to achieve the objectives of the solutions of aspects.

In addition, functional units in the aspects of this application may be integrated into one processing unit, or each of the units may exist alone physically, or two or more units may be integrated into one unit. The integrated unit may be implemented in a form of hardware, or may be implemented in a form of a software function unit.

When the integrated unit is implemented in the form of a software function unit and sold or used as an independent product, the integrated unit may be stored in a computer-readable storage medium. Based on such an understanding, the technical solutions of this application essentially, or a part contributing to the related art, or all or a part of the technical solutions may be implemented in a form of a software product. The computer software product is stored in a storage medium, and includes a plurality of instructions for enabling a computer device (which may be a personal computer, a server, a network device, or the like) to perform all or a part of the steps of the method in the aspects of this application. The above storage medium includes various media that can store program code, such as a USB flash drive, a mobile hard disk drive, a read-only memory (ROM), a random access memory (RAM), a magnetic disk, or an optical disc.

The above aspects are merely used for describing the technical solutions of this application, and are not intended to limit this application. Although this application is described in detail with reference to the above aspects, it is to be understood by a person skilled in the art that, modifications may still be made to the technical solutions described in the above aspects, or equivalent replacements may be made to some technical features therein; and the modifications or replacements do not cause the essence of corresponding technical solutions to depart from the spirit and scope of the technical solutions in the aspects of this application.

What is claimed is:

1. A method, comprising:
generating, based on running data of a virtual scene, a query feature of a virtual object in a virtual scene wherein the query feature describes aspects of the virtual object;
increasing, based on the aspects of the virtual object, a feature dimension of the virtual object using a neural network; and
generating, based on the virtual object, animation data using the neural network.

2. The method of claim 1, wherein the virtual object comprises one or more combined features of the virtual object in a current frame, and wherein the generating animation data of the virtual object comprises:
outputting, based on the combined feature, a supplemental combined feature of the virtual object in a next frame from the current frame using the neural network; and
generating, based on the combined feature, animation data of the virtual object through the using the neural network.

3. The method of claim 2, the increasing a feature dimension of the virtual object further comprising:
outputting the combined feature of the virtual object through a feature generation network in the neural network based on a latest outputted trajectory feature and bone feature of the virtual object in a case that changes of the trajectory feature and the bone feature of the virtual object satisfy a first preset condition and/or a time interval from previous combined feature outputting of the feature generation network satisfies a second preset condition.

4. The method according to claim 2, wherein the outputting comprises:
outputting, based on the combined feature of the virtual object in the current frame and a delta time of an animation engine adapting to the virtual scene, the combined feature of the virtual object in the next frame of the current frame through the feature updating network.

5. The method of claim 2, further comprising training the neural network is trained using actions comprising:
obtaining motion capturing data;
obtaining root motion data, comprising a trajectory feature and a bone feature of a motion body;
extracting a feature value of the motion body from the root motion data;
combining, based on the trajectory feature of the motion body, a bone feature of the motion body;
updating the neural network with combined features in the current frame and a combined feature of the motion body in the next frame outputted by a feature generation network in the neural network, wherein the combined feature of the motion body in the next frame is obtained based on the motion capturing data of the motion body; and
using the root motion data of the motion body and the combined feature of the motion body in the next frame outputted by the feature generation network.

6. The method of claim 5, wherein the obtaining motion capturing data comprises:
performing motion capturing on the motion body in a case that the motion body moves based on a preset motion capturing route and performs a preset motion, to obtain initial motion capturing data; and
adapting to the virtual scene using noise reduction, data extension, or generation of data in a coordinate system of an animation engine.

7. The method of claim 6, further comprising:
extracting data on the initial motion capturing data through a mirroring method; and
performing the data extension on the initial motion capturing data in a timeline zooming manner.

8. The method of claim 6, further comprising:
extracting data on the initial motion capturing data through a mirroring method; or
performing the data extension on the initial motion capturing data in a timeline zooming manner.

9. The method of claim 1, further comprising:
extracting a motion control signal for the virtual object from the running data of the virtual scene; and
generating the aspects of the virtual object based on a control parameter in the motion control signal and a historical control parameter in a historical motion control signal for the virtual object.

10. The method of claim 1, wherein the virtual object further comprises a trajectory feature comprising a trajectory velocity and a trajectory direction, and the virtual object further comprises a bone feature that comprises left-foot bone position information, left-foot bone rotation information, right-foot bone position information, and right-foot bone rotation information, a trajectory being formed based on a projection of a hip bone.

11. An apparatus, comprising:
a processor; and
memory storing computer-readable instructions that, when executed, cause the apparatus to perform:
generating, based on running data of a virtual scene, a query feature of a virtual object in a virtual scene wherein the query feature describes aspects of the virtual object;
increasing, based on the aspects of the virtual object, a feature dimension of the virtual object using a neural network; and
generating, based on the virtual object, animation data using the neural network.

12. The apparatus of claim 11, wherein the virtual object comprises one or more combined features of the virtual object in a current frame, and wherein the generating the animation data includes:
outputting, based on the combined feature, a supplemental combined feature of the virtual object in a next frame from the current frame using the neural network; and
generating, based on the combined feature, animation data of the virtual object through the using the neural network.

13. The apparatus of claim 12, wherein the increasing the feature dimension of the virtual object includes:
outputting the combined feature of the virtual object through a feature generation network of the neural network based on a latest outputted trajectory feature and bone feature of the virtual object in a case that changes of the trajectory feature and the bone feature of the virtual object satisfy a first preset condition and/or a time interval from previous combined feature outputting of the feature generation network satisfies a second preset condition.

14. The apparatus of claim 12, wherein the outputting comprises:
outputting, based on the combined feature of the virtual object in the current frame and a delta time of an animation engine adapting to the virtual scene, the combined feature of the virtual object in the next frame of the current frame through the feature updating network.

15. The apparatus of claim 11, wherein the computer-readable instructions, when executed, further cause the apparatus to perform:
extracting a motion control signal for the virtual object from the running data of the virtual scene; and
generating the aspects of the virtual object based on a control parameter in the motion control signal and a historical control parameter in a historical motion control signal for the virtual object.

16. A non-transitory computer-readable storage medium, configured to store a computer program, the computer program, when executed by an animation data generation device, is configured to perform actions comprising:
generating, based on running data of a virtual scene, a query feature of a virtual object in a virtual scene wherein the query feature describes aspects of the virtual object;
increasing, based on the aspects of the virtual object, a feature dimension of the virtual object using a neural network; and
generating, based on the virtual object, animation data using the neural network.

17. The non-transitory computer-readable storage medium of claim 16, wherein the virtual object comprises one or more combined features of the virtual object in a current frame, and wherein generating the animation data comprises:
outputting, based on the combined feature, a supplemental combined feature of the virtual object in a next frame from the current frame using the neural network; and
generating, based on the combined feature, animation data of the virtual object through the using the neural network.

18. The non-transitory computer-readable storage medium of claim 17, wherein increasing the feature dimension of the virtual object comprises:
outputting the combined feature of the virtual object through a feature generation network of the neural network based on a latest outputted trajectory feature and bone feature of the virtual object in a case that changes of the trajectory feature and the bone feature of the virtual object satisfy a first preset condition and/or a time interval from previous combined feature outputting of the feature generation network satisfies a second preset condition.

19. The non-transitory computer-readable storage medium of claim 17, wherein the outputting comprises:
outputting, based on the combined feature of the virtual object in the current frame and a delta time of an animation engine adapting to the virtual scene, the combined feature of the virtual object in the next frame of the current frame through the feature updating network.

20. The non-transitory computer-readable storage medium of claim 16, wherein the computer program is further configured to perform:
extracting a motion control signal for the virtual object from the running data of the virtual scene; and
generating the aspects of the virtual object based on a control parameter in the motion control signal and a historical control parameter in a historical motion control signal for the virtual object.
